(19) United States
(12) Patent Application Publication
(10) Pub. No.: US 2001/0045323 A1
(43) Pub. Date: Nov. 29, 2001

(54) Fire escape netting

(76) Inventor: John L. May, Beaumont, TX (US)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 09/862,016

(22) Filed: May 21, 2001

Related U.S. Application Data
(60) Provisional application No. 60/206,227, filed on May 22, 2000.

(51) Int. Cl. E06C 1/52; E06C 5/26

(52) U.S. Cl. 182/70; 182/196

(57) ABSTRACT

A fire escape mechanism that utilizes a web configuration of heat tolerant, low heat conductive, light weight, and high strength material that is extended along the height of a multi-story building such that individuals in the building an escape from a fire in the building by exiting the building directly onto the fire escape web and lower themselves to safety by climbing down its length.

### CROSS-REFERENCE TO RELATED APPLICATIONS

This applications claims the benefit of U.S. Provisional Application No. 60/206,227, filed May 22, 2000, which is incorporated herein by reference.

### STATEMENTS REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

With the advent of multi-story buildings came the need for a way of escaping from such buildings in the event of a fire. Many solutions were proposed in the decades to follow, some to be implemented, others not. One solution was to include multiple stairwells in multi-story buildings. However, the cost of multiple stairwells was significant and multiple stairwells also had its problems such as all the stairwells could become impassable at the same time as smoke filled each of the stairwells, or where fire would engulf an entire lower floor causing all of the stairwells to be blocked.

Another solution which was widely implemented was that of the use of metal stairwells attached to the outside surface of buildings. Outside stairwells provided the advantage of providing a wall between the fire within the building and those individuals trying to escape. Also, being located outside meant that the problems of smoke inhalation was greatly reduced. However, over time, the use of metal stairwells fell out of favor due to a variety of factors. One such factor was that the cost of installing and maintaining such systems was high. In addition, the perceived negative impact the device had on the aesthetic appeal of building design was another downfall. Yet another reason, was that as multi-story buildings reached the heights of modern skyscrapers, the use of such metal stairwells became impractical.

2. Description of the Related Art

There has been a number of such escape mechanisms proposed that utilize an unraveling of latter like structures from the top of buildings. One early example is the 1877 patent, now expired, U.S. Pat. No. 192,693, which utilized ladder-like devices wrapped around a shaft attached to the top edge of the exterior of the building. The ladders were said to be made out of “incombustible but flexible material” and be connected to a cable that travels inside the building for the height of the building. Another ladder device, patented in 1875, now expired, U.S. Pat. No. 170,281, included a flexible ladder that was wound around a shaft, and as that shaft is rotated, the ladder was lowered from the top of the multi-story building. The patent also discusses that the rungs made of metal tubes, and discusses how the use of rungs will be fire proof. Yet another patent from the late 1800's, now expired, U.S. Pat. No. 638,600, discussed the use of asbestos-fiber cloth sleeves which covers steel or iron ropes of a ladder-type device.

### BRIEF SUMMARY OF THE INVENTION

A fire escape mechanism for use with multi-story buildings using a web of interconnected members using material that is highly heat tolerant, light weight, and high strength, which when deployed extends along the height of the building allowing individuals in the building to exit the building onto the web and lower themselves to safety by climbing down its length.

### BRIEF DESCRIPTION OF THE SEVERAL VIEWS OF THE DRAWINGS

The object, advantages, and features of the invention will become more apparent by reference to the drawings which are appended hereto and wherein like numerals indicate like parts and wherein an illustration of the invention is shown, of which:

FIG. 1 is a perspective elevational view of the preferred embodiment of the fire escape netting system deployed in its extended state on a multi-story building.

### DETAILED DESCRIPTION OF THE INVENTION

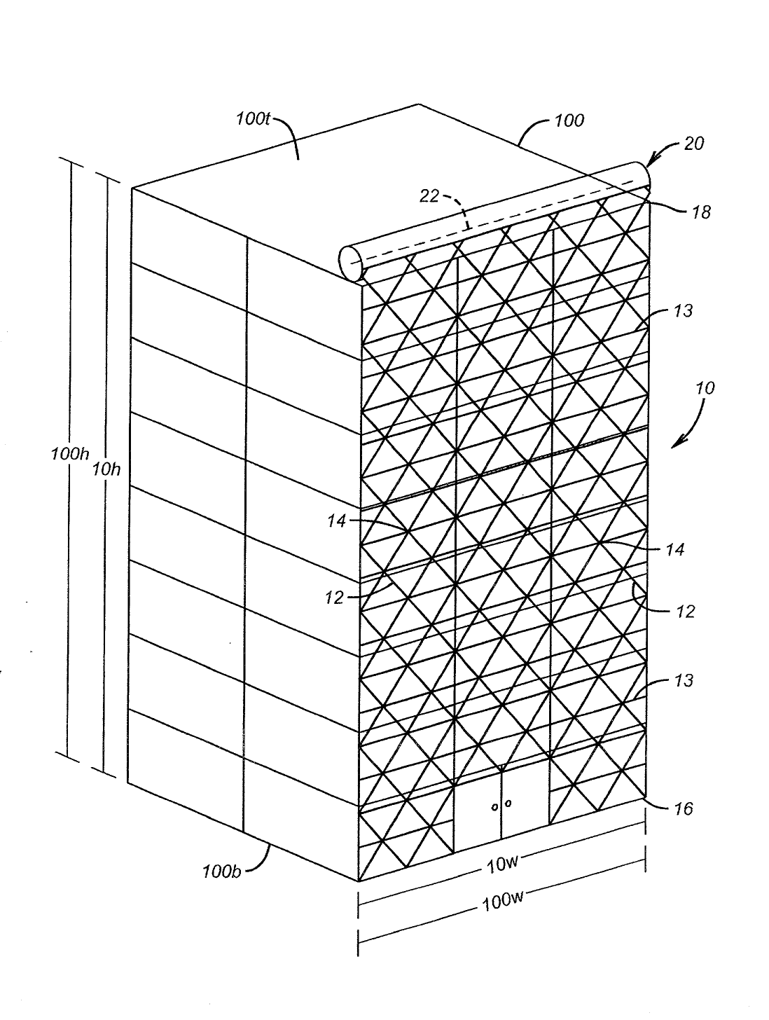

The fire escape netting system of the present invention is shown in FIG. 1. The preferred embodiment comprises: a web, generally indicated at 10, and storage compartment, generally indicated at 20. Although the preferred embodiment is shown in regards to a rectangular building with a planar surface, the fire escape netting system can be deployed on buildings of a wide variety of shapes.

As shown in the Figure, web 10 includes web top 18, web bottom 16, web members 12, web cross members 13, and web connections 14. The preferred embodiment includes a web 10 with width 10w that is equal to the building width 100w. In addition, the preferred embodiment includes web 10 with a length 10h that is equal to building height 100h. The web is preferably made out of a composite material of polymers and/or plastics, which is flame retardant and heat resistant, and preferably a good insulator. Other embodiments may use a web 10 width 10w that is smaller than, or larger than building width 100w. Other embodiments may also use a web 10 of height 10h that is longer than or shorter than building height 100h. For example, multiple webs can be deployed at various floors of a building forming a web of overlapping webs. The web need not be entirely one material. In some embodiments, the web, for example, is to include reinforcement material that has characteristics different from the material those escaping from the building would principally climb upon. The web as constructed needs to support its own weight. In addition, the web needs to support the weight of all those individuals using the web during a fire evacuation. Further, in those embodiments in which the web is deployed at a controlled rate, for example, by a rotating shaft, the deployment mechanism may be designed such that it would accommodate the additional forces introduced by individuals who engage the web before its full deployment. The preferred embodiment also is formed such that when unfurled, the web does not cover the doors at ground level, thus allowing emergency personnel unobstructed access to the lower floor of the building. On very tall buildings the web may only unfurl far enough down to reach ladder ranges.

The preferred embodiment discloses web members 12 diagonally connected between web cross members 13 at web connections 14 such that the web members 12 extend substantially at a 45° angle to web cross members 13. Other embodiments may use other configurations, and other angles, for example, the web members 12 may be connected vertically such that their web connection 14 is substantially 90° with web cross members 13. In addition, although the preferred embodiment shows multiple web members 12 connected between two web cross members 13, other embodiments may use a single “Z” shaped web member 12 connected between two consecutive web cross members 13. In other embodiments, a wide variety of other web members 12 and web cross members 13 shapes and interconnections are possible, for example, “Z” shaped web cross members 13 in conjunction with circular members 12. In addition, other embodiments may use a preformed, continuous sheet as web 10 therefore eliminating what might be considered web connections 14 as the web is continuous throughout its length. Yet, other embodiments may use a ladder-like design where web members 12 are arranged into a single pair of vertical columns extending the building height 100h and where such columns are connected to one another by a series of substantially equally spaced web cross members 13 that are connected at substantially a 90° angle to each column via web connections 14. In addition, other embodiments may incorporate other structures within the web itself, or attachments thereto, forming, or capable of forming, features having a third dimension such as pockets, ledges, troughs or tubular formations.

Storage compartment 20, also known as housing 20, is the location and device where web 10 is stored while in its non-deployed or retracted state. In the preferred embodiment storage compartment 20 is referred to as the roll housing. The preferred embodiment has web 10 wrapped about shaft 22 which when rotated results in the lowering of web 10 down the height 100h of building 100 where web 10 remains substantially next to the surface of building 100t as it is lowered. In the preferred embodiment the storage compartment 20 is located at the top of the building, offset from the edge of the building top 100t such that it is not readily visible from typical observational views. The installation dictated by the preferred embodiment will not distract from the building's appearance. In addition, in the preferred embodiment weights are attached at web bottom 16 to insure proper deployment of web 10. Other embodiments may not use a shaft 22; for example, web 10 may be wrapped about itself or loosely placed in the storage compartment 20. Yet other embodiments may not unfurl web 10 entirely at the top 100t of building 100, for example, web 10 may be deployed by sending the rolled web 10 off the top of the building allowing it to unfurl along the height 100h of building 100. Other embodiments may not use weights to deploy web 10 or may use such weights but place them in locations other than web bottom 16.

In its typical state, web 10 would be in a rolled-up state at the top 100t of building 100 within storage compartment 20. Upon detection of fire, shaft 22 would rotate such that web bottom 16 would begin to extend down the face of building 100. Shaft 22 would continue to rotate until web 10 was fully extended along web height 10h, as shown in FIG. 1. In its fully extended state, individuals in the building would exit the building windows and openings onto web 10 and lower themselves along the face of building 100 until they reach the web bottom 16 and the building bottom 100b. After web 10 had been fully extended, and the fire having been extinguished, and the use of the web 10 deemed to have been complete, web 10 is then raised along the face of building 100 by the rotation of shaft 22 such that web 10 returns to its rolled-up state at the top 100t of building 100 within storage compartment 20. A number of alternatives are possible, such as a “trap door” style mechanism to drop the web 10 where the web 10 is stored loosely in storage compartment 20.

The foregoing disclosure and description of the preferred embodiment are illustrative and explanatory thereof, and various changes in the components, circuit elements, circuit configurations, and signal connections, as well as in the details of the illustrated circuitry and construction and method of operation may be made without departing from the spirit and scope of the invention.

We claim:

1. A web for escaping from a multi-story structure, comprising:
a web of composite polymer or plastic materials having the properties of highly heat tolerant, light weight and high strength the web having a retracted state and an extended state,
wherein the web is dimensioned to extend along the outside of the multi-story structure to permit occupants to escape from a fire.

2. The web of claim 1, the web further comprising:
web cross members; and
web members,
wherein the web cross members extend horizontally across the web, and
wherein the web members extend between the cross members.

3. The web of claim 2, wherein the web members connect to the web cross members at substantially a 45° angle.

4. The web of claim 2, wherein the web members connect to the web cross members at substantially a 90° angle.

5. The web of claim 2, wherein the web members are of a singular continuous piece across the width of the web and conform to a zig-zag type pattern between web cross members.

6. The web of claim 2, wherein the web members and the web cross members are part of a continuous and singularly formed web.

7. The web of claim 2, wherein web members extend in a pair down the length of the web and wherein the web cross members are connected between the web members at substantially a 90° angle.

8. The web of claim 1, wherein the web is formed from a sheet.

9. A fire safety apparatus for escaping a multi-story structure in case of fire, comprising:
a web of composite polymer or plastic materials having the properties of highly heat tolerant, light weight and high strength and adapted to be deployed across a face of the structure from a retracted state to an extended state; and
a deployment mechanism coupled to the web and adapted to transition the web between the retracted state and the extended state.

10. The fire safety apparatus of claim 9 wherein the web in the extended state extends from substantially the top of the building to substantially the bottom of the building.

11. The fire safety apparatus of claim 9 wherein the web in the extended state extends substantially across the width of the building.

12. The fire safety apparatus of claim 9, wherein the web in the retracted state is above the top of the building.

13. The fire safety apparatus of claim 9, wherein the web in the retracted state is below the top of the building.

14. The fire safety apparatus of claim 9, wherein the deployment mechanism further comprises:
a rotatable shaft, and
wherein the web in the retracted state is wrapped about the rotatable shaft.

15. The fire safety apparatus of claim 9, further comprising:
a weight,
wherein the weight is attached to the web at or near the web bottom relative to the structure when the web is in the extended state.

16. The fire safety apparatus of claim 9, further comprising:
a housing,
wherein the web in the retracted state resides substantially within the housing, and
wherein the web in the extended state resides substantially outside the housing.

17. The fire safety apparatus of claim 16, wherein the web in the retracted state is in a rolled up configuration.

18. The fire safety apparatus of claim 16, wherein the web in the retracted state is in a furled configuration.

19. The fire safety apparatus of claim 16, further comprising:
an aperture in the housing; and
the aperture having an open and closed position,
wherein the aperture in the closed position maintains the web in the retracted state, and
wherein the aperture in the open position allows the web to transition between the retracted state and the extended state.

20. The method of escaping from a multi-story structure, the method comprising the steps of:
forming a web of composite polymer or plastic materials having the properties of highly heat tolerant, light weight and high strength the web having a retracted state and an extended state;
placing the web in the retracted state at or near the top of the multi-story structure; and
deploying the web in the extended state such that the web is deployed about the face of the multi-story structure.
